(19) United States
(12) Patent Application Publication
(10) Pub. No.: US 2024/0256921 A1
(43) Pub. Date: Aug. 1, 2024

(54) METHOD FOR GENERATING A ZONE SPECIFIC APPLICATION MAP FOR TREATING AN AGRICULTURAL FIELD WITH PRODUCTS

(71) Applicant: BASF AGRO TRADEMARKS GMBH, Ludwigshafen (DE)

(72) Inventors: Maria TACKENBERG, Münster (DE); Andreas JOHNEN, Münster (DE); Johannes Fabian SCHAEFER, Langenfeld (DE)

(21) Appl. No.: 18/561,022

(22) PCT Filed: May 18, 2022
(86) PCT No.: PCT/EP2022/063385

§ 371 Date: Nov. 15, 2023

(30) Foreign Application Priority Data
May 19, 2021 (EP) 21174746.4

(51) Int. Cl. G06N 5/022; G06Q 30/0601

(52) U.S. Cl. CPC G06N 5/022; G06Q 30/0631

(57) ABSTRACT

A method for generating a zone specific application map (8) for treating an agricultural field with products is provided. The method comprises providing a hypermodel (1) comprising a product recommendation model, PRM (2) and a biophysical parameter model, BPM (3). The method further comprises providing PRM input parameters (4) for the product recommendation model (2) and generating PRM output (5) by the product recommendation model (2). The method also comprises providing BPM input parameters (6) for the biophysical parameter model (3) and generating BPM output (7) by the biophysical parameter model (3). Finally, the method comprises generating the zone specific application map (8) by the hypermodel (1), using at least parts of the PRM output (5) and parts of the BPM output (7). Further, a system (19) for generating a zone specific application map (8), a computer program element, a use of a zone specific application map (8) and an agricultural equipment (23) are provided.

### FIELD OF THE INVENTION

The present invention relates to digital farming. In particular, the present invention relates to a method for generating a zone specific application map for treating an agricultural field with products and to a system for generating a zone specific application map. The present invention further relates to a computer program element, a use of a zone specific application map, zone specific control data and/or a zone specific control map as well as an agricultural equipment.

### BACKGROUND OF THE INVENTION

Treatment of agricultural fields with products such as fungicides, herbicides, insecticides, acaricides, molluscicides, nematicides, avicides, piscicides, rodenticides, repellants, bactericides, biocides, safeners, plant growth regulators, urease inhibitors, nitrification inhibitors and/or denitrification inhibitors is commonly performed in order to increase the yield of the agricultural field. Also, various models have been developed to determine the optimal kind and amount of products to be applied to the agricultural field. However, these models do not take into account local variations within the agricultural field. Even though not every zone of the agricultural field requires the same amount and/or kind of product to be applied, this has not been included in the models as yet.

### SUMMARY OF THE INVENTION

It is therefore an object of the present invention to provide a method for generating a product application map that takes local variations into account.

The object of the present invention is solved by the subject-matter of the independent claims, wherein further embodiments are incorporated in the dependent claims.

According to a first aspect of the invention, a method for generating a zone specific application map for treating an agricultural field with products is provided.

In this context, the term “agricultural field” is understood to be any area in which organisms, particularly crop plants, are produced, grown, sown, and/or planned to be produced, grown or sown. The term “agricultural field” also includes horticultural fields and silvicultural fields.

Preferred crops are Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays. Most preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

The term “zone” is understood to be a sub-field zone or a part of the agricultural field, i.e., the agricultural field can be spatially divided into more than one zone, wherein each zone may have different properties.

The term “application map” is understood to be a map indicating a two-dimensional spatial distribution of the amounts, dose rates, types and/or forms of products which should be applied on the different zones within the agricultural field.

According to the method, a hypermodel is provided. In this context, a hypermodel is a model comprising at least two subordinate models and linking the subordinate models. Said linking of the subordinate models may comprise linking of the output of the subordinate models and/or linking output of the subordinate models to input of the subordinate models. In particular, the hypermodel may control an interdependence of the subordinate models in an iterative procedure. For this, the hypermodel may be configured to set initial input parameters for the subordinate models, such as preset or standard values, and then iteratively run the subordinate models, collect the output of the subordinate models and use said output of the subordinate models as input for the subordinate models in the next iteration. Further, the hypermodel may be configured to stop the iterative procedure after a pre-defined number of iterations or after a pre-defined accuracy has been reached. Finally, the hypermodel may be configured to collect the final results of the subordinate models, optionally transform them, and output the results. The hypermodel comprises a product recommendation model (PRM) and a biophysical parameter model (BPM). For the product recommendation model, PRM input parameters are provided. Based on said PRM input parameters, the product recommendation model generates a PRM output. Likewise, for the biophysical parameter model, BPM input parameters are provided. In this context, biophysical parameters are parameters relating to properties of the crop plants that can by physically measured, such as a leaf area index, canopy density, height, biomass or chlorophyll content. Based on said BPM input parameters, the biophysical parameter model generates BPM output. That is, the product recommendation model and the biophysical parameter model are performed as part of the hypermodel. At least parts of the PRM output and parts of the BPM output are then used by the hypermodel to generate the zone specific application map. In particular, the zone specific component stems from the biophysical parameter model. Based on the zone specific application map, the agricultural field may be treated with products such that each zone of the agricultural field is treated with an amount and/or selection of products optimized for the respective zone. Hence, the yield of the agricultural field may be optimized for each zone and the correct amount of products is chosen for each zone. Zones of the agricultural field that need less of the products are treated with a smaller amount of the products, both saving costs for acquiring the products and preventing an unnecessary over-usage of products, which is environmentally more friendly. On the other hand, zones of the agricultural field that need more of the products are treated with a greater amount of the products, resulting in a greater yield of the specific zone which would not be achieved with a smaller amount of the products.

The method may be implemented on a computing device, e.g., a tablet computer, a personal computer or a supercomputer. In particular, the parts of the hypermodel may be executed on separate processors, parallelizing and therefore speeding up the execution of the method.

According to an embodiment, the hypermodel further comprises a growth stage model (GSM). In this context, growth stages may include germination, sprouting, bud development, leaf development, formation of side shoots, tillering, stem elongation or rosette growth, shoot development, development of harvestable vegetative plant parts, bolting, inflorescene emergence, heading, flowering, development of fruit, ripening or maturity of fruit and seed, senescence and beginning of dormancy. For the growth stage model, GSM input parameters are provided and the growth stage model generates GSM output based on said GSM input parameters. The growth stage model is also performed as part of the hypermodel, adding information about the growth stage of the crops to the hypermodel.

At least parts of the GSM output may be used as PRM input parameters. That is, the product recommendation model may depend on the growth stage of the crops. As an example, the use of some products is linked to a certain growth stage of the crops, e.g., some products are most effective when applied to seedlings whereas other products are most effective when applied to blooming crops. Receiving the growth stage as an input, the products that fit best to the current or expected growth stage of the crops may be recommended.

According to an embodiment, the hypermodel further comprises a disease and infection risk model (DIRM). For the disease and infection risk model, DIRM input parameters are provided. Based on said DIRM input parameters, the disease and infection risk model generates DIRM output. The disease and infection risk model is also performed as part of the hypermodel, adding information about the risk that the crops may be infected with a disease and/or the risk that a disease may affect the crops and therefore the yield of the agricultural field to the hypermodel.

The DIRM input parameters comprise at least parts of the GSM output. That is, the disease and infection risk model depends on the growth stage of the crops. This improves the disease and infection risk model, since the susceptibility of crops to infections and diseases varies with the growth stage of the crops.

Further, the PRM input parameters comprise at least parts of the DIRM output. That is, the product recommendation model depends on the disease and infection risk of the crops. This improves the product recommendation model, since different disease and infections risks imply different products to be applied to the agricultural field.

According to an embodiment, the zone specific application map comprises a selection of products and a product rate per zone of the agricultural field. That is, per zone of the agricultural field, one or more products to treat that zone with and the corresponding product rate are provided by the zone specific application map. The product rate is given, e.g., as weight or volume of the product per unit area. The agricultural field comprises a plurality of zones and each zone may be a polygon-shaped cell of the agricultural field. More particularly, the zones may be square cells of the agricultural field. As an example, each square may correspond to a pixel of a satellite image.

According to an embodiment, the products comprise at least one of a group, the group consisting of chemical products, biological products, fertilizers, nutrients and water. In particular, combinations of products and/or substances may be used. The products and/or their combinations may be labeled by a product ID such that a user and/or an agricultural equipment may select said product and/or combination based on the product ID. The chemical products may be fungicides, herbicides, insecticides, acaricides, molluscicides, nematicides, avicides, piscicides, rodenticides, repellants, bactericides, biocides, safeners, plant growth regulators, urease inhibitors, nitrification inhibitors, denitrification inhibitors, or any combination thereof. The biological products may be microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof. Said products increase the yield of the agricultural field, e.g., by preventing diseases and/or by supporting the growth of the crops.

According to an embodiment, the GSM input parameters comprise at least one out of a group, the group consisting of crop, variety, variety characteristics, raw weather data, seeding date and growth stage observation. Variety refers to a variety of a crop and may be provided as a crop variety identifier or as a trade name. Variety characteristics refer to the specific characteristics of a crop variety which may be provided, e.g., as deviation from a “base” crop. Raw weather data may include air temperatures, soil temperatures, precipitation and sunshine duration. Growth stage observations are observations of the actual growth stage of the crops in the agricultural field. Said observations may have been obtained, e.g., by a user and entered manually or by automatic observations in the agricultural field.

The GSM output comprises the distribution of growth stages over the season, in particular with a daily resolution. The growth stage may be provided, e.g., on the BBCH scale. The BBCH scale provides numerical codes for growth stages of the crop such as germination, sprouting, bud development; leaf development; formation of side shoots, tillering; stem elongation or rosette growth, shoot development; development of harvestable vegetative plant parts, bolting; inflorescene emergence, heading; flowering; development of fruit; ripening or maturity of fruit and seed; and senescence, beginning of dormancy.

As an example, the growth stage model may take the crop and the seeding date as input parameters and generate the growth stage as output, e.g., based on a look-up table. Of course, more sophisticated models and more input parameters will lead to more precise growth stage predictions.

The DIRM input parameters comprise at least one out of a group, the group consisting of crop, previous crop, variety, variety characteristics, raw weather data, seeding date, infection rules, tillage and disease observations. The previous crop relates to a crop that was planted on the agricultural field either earlier in the season or during a previous year. The previous crop information may comprise the dates when the previous crop was planted on the agricultural field. Infection rules may comprise any kind of rules that describe the infection of crops, taking into account, e.g., the growth stage of the crop, the weather and/or occurrence of germs. Tillage may comprise any kind of tillage information, such as dates and details of the tillage performed on the agricultural field. Disease observations may have been obtained, e.g., by a user and entered manually or by automatic observations, taken, e.g., by stationary or non-stationary cameras, in the agricultural field.

The DIRM output comprises disease and infection data, in particular disease and infection risk and disease and infection events, particularly for the past, the present and the future. The disease and infection risk and/or events comprise the kind of disease, dates of the infection or disease and the severity of the disease and/or infection.

As an example, the disease and infection risk model may take the crop and the growth stage of the crop as input parameters and generate the disease and infection risk, for at least one disease or infection, as output. For this, tables containing a plurality of crops and their infection risk as a function of growth stage may be used. Again, more sophisticated models and more input parameters will lead to more precise disease and infection risk predictions.

The PRM input parameters comprise at least one out of a group, the group consisting of crop, variety, variety characteristics, indication, product registration, efficacy requirements of products and observational data. Indication refers to a valid reason to use a product and comprises, in particular, the effectiveness of a certain product to fight a disease or enhance the growth of the crop. Product registration refers to the registration of the product and may include information on under which circumstances a product may be used. Efficacy requirements of products include further requirements for a product to be efficient, such as growth stage of the crop or weather conditions.

The PRM output comprises a selection of products and a product rate. In particular, the PRM output may provide different alternatives that may be used. Preferably, the PRM output further comprises a dependence of selected products and/or the product rate on a biophysical parameter. Using the PRM output with said dependence on the biophysical parameter together with the BPM output, the hypermodel may determine the recommended product and product rate for each zone of the agricultural field.

As an example, the product recommendation model may take the crop, the growth stage and the disease and infection risk as input parameters and generate a recommended product as output. In a simple implementation, a look-up table with preferred products may be used to generate the output. Again, more sophisticated models and more input parameters will lead to more precise product recommendations.

The BPM input parameters comprise remote image data of the agricultural field. Said remote image data is in particular multi-spectral image data. The remote image data may be provided by a satellite, an aircraft and/or a drone. In particular, pixels of the remote image data may correspond to the zones of the agricultural field.

The BPM output comprises the zone specific distribution of a biophysical parameter, in particular a leaf area index and/or a canopy density. As an example, the leaf area index may be defined as the one-sided green leaf area per unit ground surface area. As another example, the canopy density may be defined as the projection of the green leaf area per unit ground surface area.

As an example, the biophysical parameter model may take multi-spectral image data as input and produce a leaf area index as output. Here, the leaf area index may be computed as a simple function from the multi-spectral image data. Again, more sophisticated models and more input parameters will lead to more precise biophysical parameters.

To generate the zone specific application map, the hypermodel may, as an example, combine the product recommendation from the product recommendation model and the leaf area index from the biophysical parameter model to generate the zone specific application map. In a simple implementation, the product may be taken directly from the product recommendation model and the product rate per zone may be computed as a function of the leaf area index.

According to an embodiment, the growth stage model is a process model. In this context, a process model is a model in which certain functions of and/or dependences between parameters are provided by a user. These functions and/or dependences may be simple functions and may be based on past observations. Alternatively or additionally, the growth stage model may be a machine learning model such as a decision tree, a computer-implemented neural network or an artificial neural network or any combination thereof. For training the machine learning model, training data is split into two parts, one for training and one for testing, e.g., 90% of the data for training and 10% for testing. When training and testing the machine learning model, a mean absolute error may be used as evaluation metric. In particular, the mean absolute error may refer to the error on the BBCH scale for a given day or to the error in time for a given BBCH code.

According to an embodiment, the disease and infection risk model is a process model or a machine learning model. A mean absolute error that may be used as evaluation metric for the machine learning model may refer to an amount of disease occurrence for a given day.

According to an embodiment, the product recommendation model is a process model or a machine learning model. A mean absolute error that may be used as evaluation metric for the machine learning model may refer to an amount of a given product to be applied to the agricultural field.

According to an embodiment, the biophysical parameter model is a process model or a machine learning model. A mean absolute error that may be used as evaluation metric for the machine learning model may refer to the leaf area index and/or the canopy density.

According to an embodiment, at least parts of the GSM output are used as some of the BPM input parameters, e.g., the growth stage on the BBCH scale may be used as BPM input parameter. Modeling the biophysical parameters may be improved by having a growth stage prediction as an input.

According to an embodiment, at least parts of the DIRM output are used as some of the GSM input parameters, e.g., predicted disease and infection events may be used as GSM input parameter. Hence, the influence of diseases on the growth stage of the crops on the agricultural field is included.

According to an embodiment, at least parts of the DIRM output are used as some of the BPM input parameters, e.g., predicted disease and infection events may be used as BPM input parameter. This further includes the influence of diseases on the biophysical parameters.

According to an embodiment, at least parts of the PRM output are used as some of the GSM input parameters, e.g., a recommended product may be used as GSM input parameter. Hence, the growth stage of the crops may be modeled taking the application of products to the agricultural field into consideration.

According to an embodiment, at least parts of the PRM output are used as some of the DIRM input parameters, e.g., a recommended product may be used as DIRM input parameter. Hence, the development of diseases may be modeled taking the application of products to the agricultural field into consideration.

According to an embodiment, at least parts of the PRM output are used as some of the BPM input parameters, e.g., a recommended product may be used as BPM input parameter. This takes into account the effect of the application of products to the agricultural field on the biophysical parameters such as the leaf area index.

According to an embodiment, the hypermodel further comprises another model. Input parameters are provided for said other model and the other model generates an output based on said input parameters. The GSM output, DIRM output, PRM output and/or BPM output may be used as some of the input parameters for the other model and the output from the other model may be uses as some the GSM, DIRM, PRM and/or BPM input parameters. An example for such other model is a weather model, wherein the weather influences the growth stage, the disease and infection risk, the product recommendation as well as the biophysical parameters.

According to an embodiment, the method further comprises generating zone specific control data and/or a zone specific control map configured to be used for controlling an agricultural equipment to apply the products to the agricultural field. A zone specific control map may, e.g., comprise nozzle pressures that are to be used for each zone of the agricultural field. Zone specific control data may, e.g., comprise the nozzle pressures that are to be used based on a distance on a given track that the agricultural equipment is requested to follow. Alternatively, the agricultural equipment may be configured to generate control signals for the treatment of the agricultural field, in particular for the application of products, based on the zone specific application map. The product is then applied to the agricultural field in agreement with the zone specific application map.

According to an embodiment, the method further comprises determining one common solution of the products for the agricultural field by the hypermodel. In this context, the “one common solution” may be one product or a mixture of products that will be applied, usually with varying application rates, to the entire agricultural field. Using just one common solution can be done with easier equipment than using different products or different solutions of said products for every zone of the agricultural field. The common solution may be determined, e.g., as an average or a median of the product amounts or concentrations over the agricultural field. Using said common solution, the zone specific application map specifies the amount per unit area of the common solution to be applied per zone of the agricultural field. Said amount per unit area of the common solution may range between a minimum value and a maximum value. Also, the amount per unit area of the common solution may be zero, i.e., no products will be applied to the respective zone of the agricultural field.

According to another aspect of the present invention, a system for generating a zone specific application map is provided. Said system is configured to carry out a method according to the above description. In particular, the system comprises at least one input interface for providing input parameters. Said input parameters comprise the GSM input parameters, the DIRM input parameters, the PRM input parameters and the BPM input parameters. The system further comprises at least one processing unit configured to generate the zone specific application map and at least one output interface for outputting the zone specific application map, zone specific control data and/or the zone specific control map. Said output interface may be a network interface adapted to broadcast the hypermodel output to an agricultural equipment.

According to another aspect of the invention, a computer program element is provided. The computer program element is configured to carry out a method according to the above description when executed by a processor in a system according to the above description.

According to another aspect of the invention, a use of a zone specific application map, zone specific control data and/or a zone specific control map for applying products to an agricultural field is provided. Here, the zone specific application map, zone specific control data and/or a zone specific control map have been generated according to a method according to the above description. By applying the products according to the zone specific application map, zone specific control data and/or a zone specific control map, an optimal amount of the product is applied to the agricultural field. In particular, the kind and amount of product is sufficient to generate a good yield of the agricultural field. Also, the amount of product is not excessive, which both saves costs and is environmentally friendly.

According to another aspect of the invention, an agricultural equipment is provided. Said agricultural equipment is equipped for applying products to an agricultural field and configured to be controlled by a zone specific application map, zone specific control data and/or a zone specific control map provided by a method according to the above description. Hence, the kind and amount of product is sufficient to generate a good yield of the agricultural field and the amount of product is not excessive, which both saves costs and is environmentally friendly.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 shows a workflow of an embodiment of a hypermodel;

FIG. 2 shows a workflow of another embodiment of a hypermodel;

FIG. 3 shows a workflow of yet another embodiment of a hypermodel;

FIG. 4 shows a workflow of yet another embodiment of a hypermodel;

FIG. 5 shows a workflow of yet another embodiment of a hypermodel;

FIG. 6 shows an example of a zone specific application map; and

FIG. 7 schematically shows a system for generating a zone specific application map and an agricultural equipment.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF EMBODIMENTS

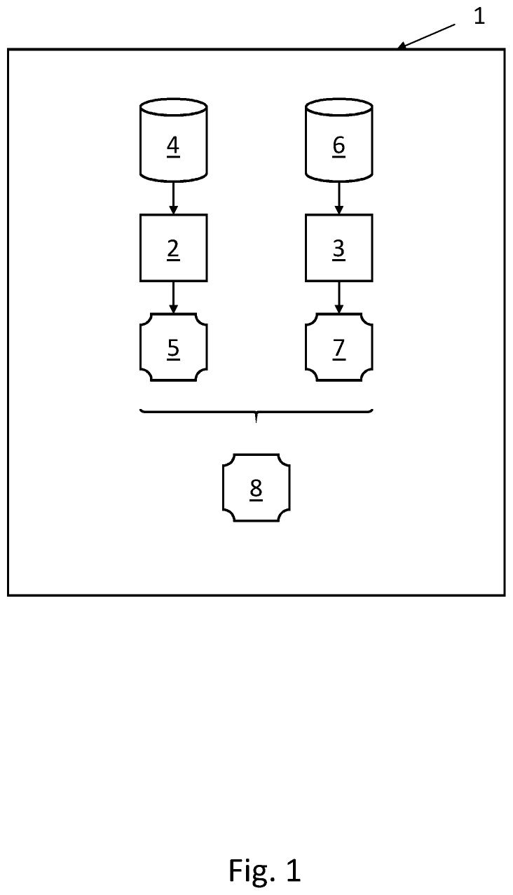

FIG. 1 shows a workflow of an embodiment of a hypermodel 1 for generating a zone specific application map for treating an agricultural field with products. Said products may be chemical products, biological products, fertilizers, nutrients and water. Zones of the agricultural field are understood to be sub-field zones or parts of the agricultural field, i.e., the agricultural field is divided into a plurality of said zones.

The hypermodel comprises a product recommendation model (PRM) 2 and a biophysical parameter model (BPM) 3. PRM input parameters 4 such as a crop, a variety, variety characteristics, indication, product registration, efficacy requirements of products and/or observational data are provided for the product recommendation model 2. Based on said PRM input parameters 4, the product recommendation model 2 generates a PRM output 5, comprising, e.g., a selection of products and a product rate. Preferably, said PRM output 5 is provided in dependence on biophysical parameters of the crop.

BPM input parameters 6 are provided for the biophysical parameter model 3. Said BPM input parameters 6 may comprise remote image data, particularly multi-spectral image data, of the agricultural field. Said remote image data may be provided by a satellite, an aircraft and/or a drone. In particular, the BPM input parameters 6 are zone-specific, i.e., the remote image data has a resolution of at least the size of a zone of the agricultural field. Based on said BPM input parameters 6, the biophysical parameter model generates BPM output 7. Said BPM output 7 may comprise the zone specific distribution of a biophysical parameter, in particular a leaf area index and/or a canopy density.

Based on the PRM output 5 and the BPM output 7, the hypermodel 1 generates the zone specific application map 8. To do so, the hypermodel 1 may make use of the biophysical parameter dependence of the PRM output 5 and combine it with the BPM output. Additionally or alternatively, a generic dependence of application rates on the biophysical parameters may be used by the hypermodel 1 to generate the zone specific application map 8 from the PRM output 5 and the BPM output 7, e.g., a linear dependence on the leaf area index.

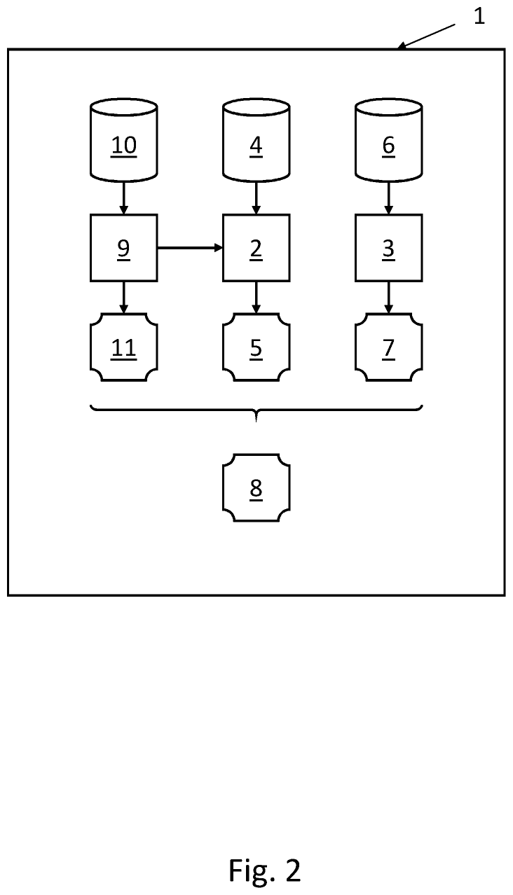

Another embodiment of a hypermodel 1 is shown in FIG. 2. In addition to the hypermodel 1 of FIG. 1, this hypermodel 1 comprises a growth stage model (GSM) 9. GSM input parameters 10 such as crop, variety, variety characteristics, raw weather data, seeding date and growth stage observation are provided for the growth stage model 9. Based on said GSM input parameters 10, the growth stage model 9 generates GSM output 11. Said GSM output 11 may comprise the distribution of growth stages over the season, in particular with a daily resolution. The GSM output 11 is also used as part of the PRM input parameters 4, i.e., the product recommendation model 2 depends on the growth stage of the crops. Consequently, a product that fits the actual growth stage of the crops best may be recommended by the product recommendation model 2.

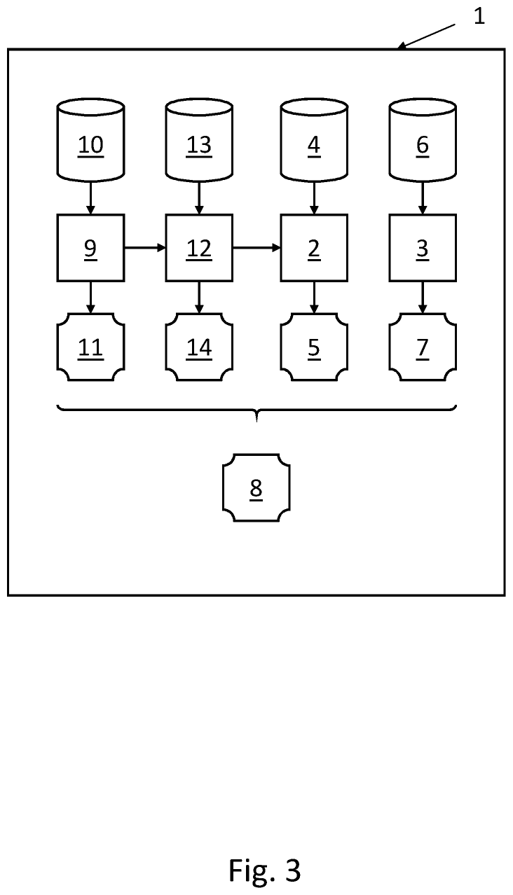

Yet another embodiment of a hypermodel 1 is shown in FIG. 3. In addition to the hypermodel 1 of FIG. 2, this hypermodel 1 comprises a disease and infection risk model (DIRM) 12. DIRM input parameters 13 such as crop, previous crop, variety, variety characteristics, raw weather data, seeding date, infection rules, tillage and disease observations are provided for the disease and infection risk model 12. Based on said input parameters 13, the disease and infection risk model 12 generates DIRM output 14. Said DIRM output 14 may comprise disease and infection data, in particular disease and infection risk and disease and infection events. Said data may be provided for the past, the present and the future.

Instead of having GSM output 11 as part of the PRM input parameters 4 as given by the hypermodel 1 of FIG. 2, DIRM output 14 is used as part of the PRM input parameters 4 in this embodiment, i.e., the product recommendation model 2 depends on the disease and infection risk of the crops, further improving the product recommendation model 2.

Also, the GSM output 11 is used as part of the DIRM input parameters 13, i.e., the disease and infection risk model 12 depends on the growth stage of the crops, further improving the disease and infection risk model 12.

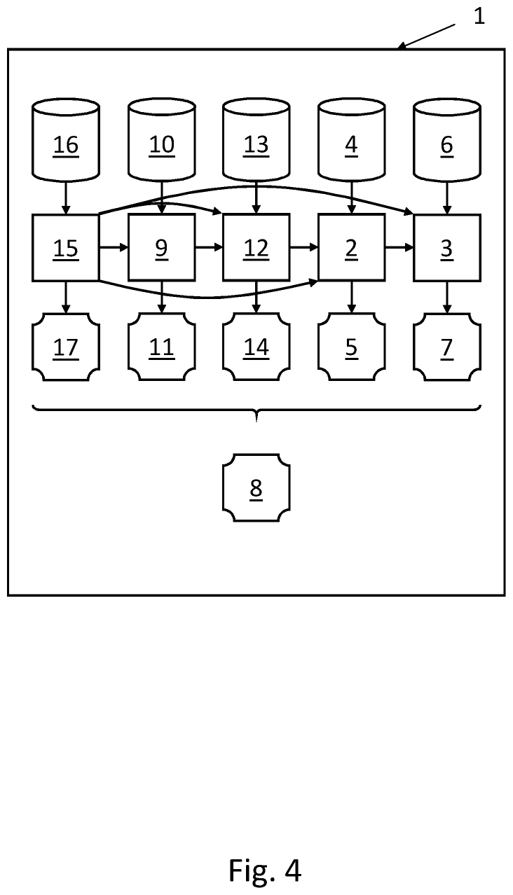

Yet another embodiment of a hypermodel 1 is shown in FIG. 4. In addition to the hypermodel 1 of FIG. 3, this hypermodel 1 comprises another model 15, e.g., a weather model. Input parameters 16 for the other model 15 are provided, in the example, e.g., past and current weather data as well as satellite images. The output 17 generated by the other model 15, based on the input parameters 16, may include in the example weather data of the past, actual weather data and in particular a weather prediction. The output 17 of the other model 15 is used as part of the input parameters 10, 13, 4, and 6 of the growth stage model 9, disease and infection risk model 12, product recommendation model 2 and biophysical parameter model 3, respectively. All of said models benefit from accurate weather data.

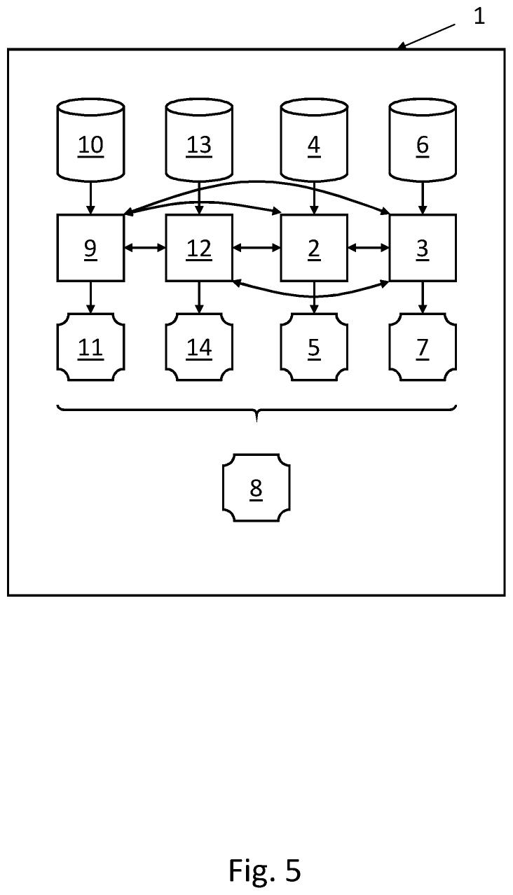

Yet another embodiment of a hypermodel 1 is shown in FIG. 5. In addition to the hypermodel 1 of FIG. 3, the GSM output 11 is used as part of the PRM input parameters 4 and as part of the BPM input parameters 6. Further, the DIRM output 14 is used as part of the GSM input parameters 10 and the BPM input parameters 6. Also, the PRM output 5 is used as part of the GSM input parameters 10, the DIRM input parameters 13 and the BPM input parameters 6. Finally, the BPM output 7 is used as part of the GSM input parameters 10, the DIRM input parameters 13 and the PRM input parameters 4. Since all of said models may depend, at least to some degree, on the output of the other models, this further improves the accuracy of the hypermodel 1. Said interdependence between the different models may be realized by iteratively running the different models. As an example, in a first run, no interdependence between the models is used. Here, the input parameters that would stem from the output of other models may be set to some standard or preset value. Then, in a second run, the outputs of the models from the first run are used as input parameters and new, more accurate output is generated. This procedure may be repeated until it converges, e.g., to a level where additional runs do not change the result significantly.

Some or all of the models, i.e., the product recommendation model 2, the biophysical parameter model 3, the growth stage model 9, the disease and infection risk model 12 and/or the other model 15, may be implemented as process models. In this context, a process model is a model in which certain functions of and/or dependences between parameters are provided by a user. That is, these models comprise algorithms that take the input parameters to generate output parameters. Here, the algorithms may have been programmed based on phenomenological observations and/or include simulations.

Alternatively, or additionally, some or all of the models may be implemented as machine learning models. Examples for machine learning models are a decision tree, a computer-implemented neural network or an artificial neural network or any combination thereof. Training data for these models may be obtained from observations and measurements obtained during past seasons. For training the machine learning model, training data is split into two parts, one for training and one for testing, e.g., 90% of the data for training and 10% for testing. When training and testing the machine learning model, a mean absolute error may be used as evaluation metric.

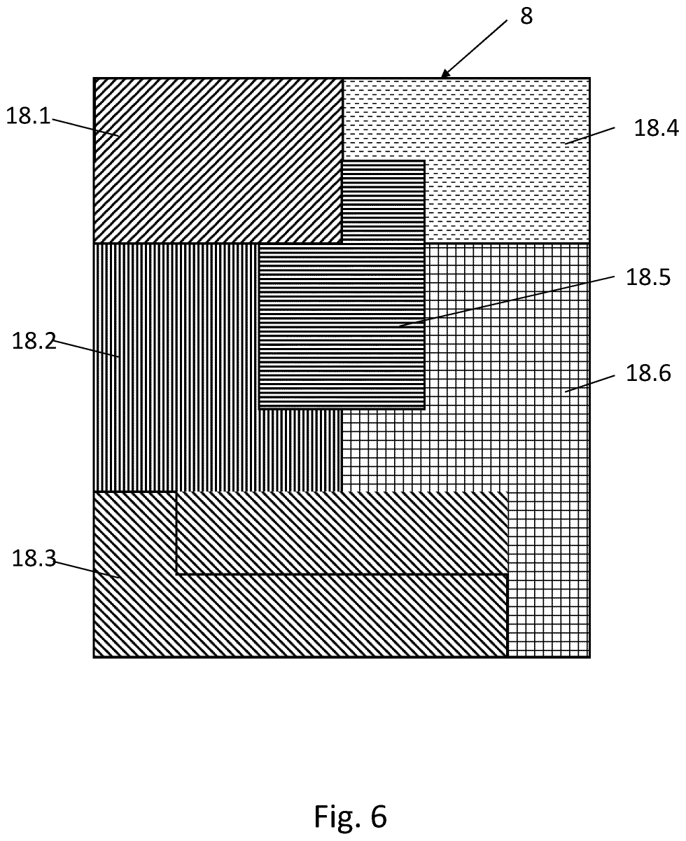

FIG. 6 shows an example of a zone specific application map 8. Several zones 18.1 to 18.6 of the agricultural field are indicated with different hachures. For each zone 18.1 to 18.6, a kind of product or a combination of products and an amount of said products to be applied to the specific zone are indicated. Alternatively, one common solution that is to be applied to the agricultural field may have been determined by the hypermodel 1. In this case, the zones 18.1 to 18.6 of the zone specific application map 8 may indicate only the amount of said common solution to be applied to the agricultural field.

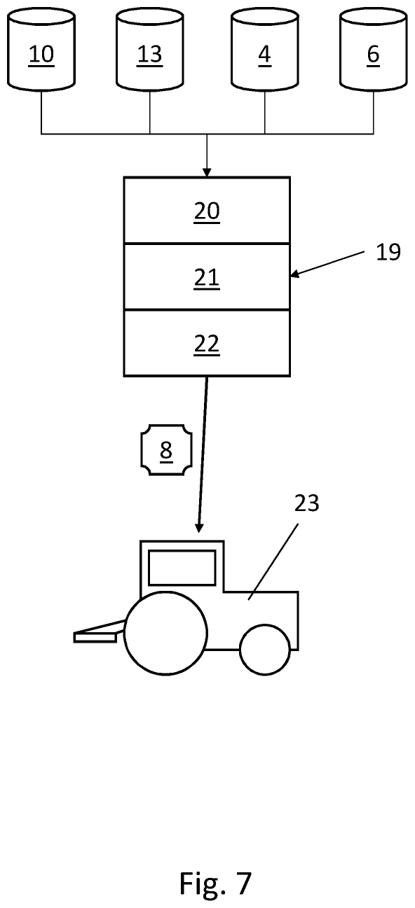

FIG. 7 shows a system 19 for generating a zone specific application map 8. Said system 19 comprises an input interface 20 for providing the input parameters. Here, GSM input parameters 10, DIRM input parameters 13, PRM input parameters 4 and BPM input parameters 6 are provided.

A processing unit 21 of the system 20 is configured to generate the zone specific application map 8 by using a hypermodel 1 according to the above description. The zone specific application map 8 is then broadcast by an output interface 22 of the system 19. Said broadcasting may be performed via a network connection and/or the internet. The zone specific application map 8 is received by an agricultural equipment 23. Using the zone specific application map 8, the agricultural equipment performs a zone 18 specific application of products to the agricultural field. Hence, the kind and amount of products is sufficient to generate a good yield of the agricultural field and the amount of products is not excessive, which both saves costs and is environmentally friendly.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for generating a zone specific application map (8) for treating an agricultural field with products, the method comprising:
providing a hypermodel (1) comprising:
a product recommendation model, PRM (2); and
a biophysical parameter model, BPM (3);
providing PRM input parameters (4) for the product recommendation model (2) and generating PRM output (5) by the product recommendation model (2);
providing BPM input parameters (6) for the biophysical parameter model (3) and generating BPM output (7) by the biophysical parameter model (3); and
generating the zone specific application map (8) by the hypermodel (1), using at least parts of the PRM output (5) and parts of the BPM output (7).

2. The method according to claim 1, wherein
the hypermodel (1) further comprises a growth stage model, GSM (9);
the method further comprises providing GSM input parameters (10) for the growth stage model (9) and generating GSM output (11) by the growth stage model (9); and
the PRM input parameters (4) optionally comprise at least parts of the GSM output (11).

3. The method according to claim 2, wherein
the hypermodel (1) further comprises a disease and infection risk model, DIRM (12);
the method further comprises providing DIRM input parameters (13), comprising at least parts of the GSM output (11), for the disease and infection risk model (12) and generating DIRM output (14) by the disease and infection risk model (12); and
the PRM input parameters (4) comprise at least parts of the DIRM output (14).

4. The method according to claim 1, wherein the zone specific application map (8) comprises a selection of products and a product rate per zone (18) of the agricultural field, wherein the zone (18) is in particular a polygon-shaped cell, more particularly a square cell.

5. The method according to claim 1, wherein the products comprise at least one out of a group, the group consisting of chemical products, biological products, fertilizers, nutrients and water.

6. The method according to claim 2,
wherein:
the GSM input parameters (10) comprise at least one out of a group, the group consisting of crop, variety, variety characteristics, raw weather data, seeding date and growth stage observation;
the GSM output (11) comprises the distribution of growth stages over the season, in particular with a daily resolution;
the DIRM input parameters (13) comprise at least one out of a group, the group consisting of crop, previous crop, variety, variety characteristics, raw weather data, seeding date, infection rules, tillage and disease observations;
the DIRM output (14) comprises disease and infection data, in particular disease and infection risk and disease and infection events, particularly for the past, the present and the future;
the PRM input parameters (4) comprise at least one out of a group, the group consisting of crop, variety, variety characteristics, indication, product registration, efficacy requirements of products and observational data;
the PRM output (5) comprises a selection of products and a product rate;
the BPM input parameters (6) comprise remote image data, particularly multi-spectral image data, of the agricultural field, in particular provided by a satellite, an aircraft and/or a drone; and/or
the BPM output (7) comprises the zone specific distribution of a biophysical parameter, in particular a leaf area index and/or a canopy density.

7. The method according to claim 1, wherein:
the growth stage model (9) is a process model or a machine learning model;
the disease and infection risk model (12) is a process model or a machine learning model;
the product recommendation model (2) is a process model or a machine learning model; and
the biophysical parameter model (3) is a process model or a machine learning model.

8. The method according to claim 1, further comprising at least one out of a group, the group consisting of:
using at least parts of the GSM output (11) as some of the BPM input parameters (6);
using at least parts of the DIRM output (14) as some of the GSM input parameters (10);
using at least parts of the DIRM output (14) as some of the BPM input parameters (6);
using at least parts of the PRM output (5) as some of the GSM input parameters (10);
using at least parts of the PRM output (5) as some of the DIRM input parameters (13); and
using at least parts of the PRM output (5) as some of the BPM input parameters (6).

9. The method according to claim 1, wherein the hypermodel (1) further comprises another model (15), in particular a weather model.

10. The method according to claim 1, further comprising generating zone specific control data and/or a zone specific control map configured to be used for controlling an agricultural equipment to apply the products to the agricultural field.

11. The method according to claim 1, further comprising determining one common solution of the products for the agricultural field by the hypermodel (1), wherein the zone specific application map (8) specifies the amount per unit area of the common solution to be applied per zone (18) of the agricultural field.

12. A system for generating a zone specific application map (8), configured to carry out a method according to claim 1 and comprising:
at least one input interface (20) for providing input parameters, the input parameters comprising at least one out of a group, the group consisting of the GSM input parameters (10), DIRM input parameters (13), PRM input parameters (4) and BPM input parameters (6);
at least one processing unit (21) configured to generate the zone specific application map (8); and
at least one output interface (22) for outputting at least one out of a group, the group consisting of the zone specific application map (8), zone specific control data and the zone specific control map.

13. A non-transitory computer-readable medium having instructions encoded thereon that, when executed by a processor in a system (19), cause the processor to carry out a method according to claim 1.

14. Use of a zone specific application map (8), zone specific control data and/or a zone specific control map generated according to a method according to claim 1 for applying products to an agricultural field.

15. Agricultural equipment equipped for applying products to an agricultural field and configured to be controlled by a zone specific application map (8), zone specific control data and/or a zone specific control map provided by a method according to claim 1.
